(19) United States
(12) Patent Application Publication
(10) Pub. No.: US 2022/0111557 A1
(43) Pub. Date: Apr. 14, 2022

(54) MICROWAVE ENHANCED CONCRETE PULTRUSION

(71) Applicant: X Development LLC, Mountain View, CA (US)

(72) Inventors: Antonio Raymond Papania-Davis, Oakland, CA (US); Neil David Treat, San Jose, CA (US)

(21) Appl. No.: 17/069,212

(22) Filed: Oct. 13, 2020

(51) Int. Cl. B28B 11/24; B28B 3/20; B28B 17/00

(52) U.S. Cl. CPC B28B 11/241; B28B 11/245; H01J 25/50; B28B 17/0081; B28B 3/20

(57) ABSTRACT

Methods, systems, and apparatus, for performing pultrusion molding with concrete. One exemplary method includes conveying a textile material through a concrete infusion system to provide a concrete infused textile material (CITM). Heating and shaping the CITM by conveying the CITM through a microwave chamber comprising an electrically non-conductive die disposed therein, the microwave chamber operable to heat concrete infused in the textile material by irradiating the CITM with microwave energy as the CITM is conveyed through the microwave chamber, and the die operable to shape the CITM as the CITM is conveyed through the microwave chamber. Cooling the CITM by conveying the CITM through a cool down chamber operable to maintain heat in the CITM as the CITM is conveyed through the microwave chamber allowing the concrete to cure while a temperature of the CITM is reduced.

### BACKGROUND

Current precast concrete production is a batch process that involves multi hour cycle times in custom molds. This process can be expedited slightly using steam or resistively heated molds as well as chemical accelerants which can reduce curing times to the 0.75-2 hour range. However, current fabrication methods cannot achieve short enough curing times to allow for continuous process manufacturing methods such as extrusion and pultrusion, which are common in metal, plastic, and composite production. The present inability to use continuous processes for concrete forming has negative implications for product cost, consistency, feasible product geometries, overall part strength, and environmental impact.

To enable continuous pultruded concrete structures, the curing time of concrete must be reduced. Presently, concrete cure times limit the creation of unique geometries (e.g. thin or hollow structures) without the use of dedicated supportive molds. Long curing times also require large factory floor areas to produce thinner, more complex and higher performing parts. Improvements are sought in the design of concrete manufacturing systems.

### SUMMARY

The disclosed idea generally relates to a system for performing pultrusion molding with concrete. In particular, a microwave reflection chamber is included in a concrete pultrusion system to mold and cure the concrete. The microwave reflection chamber can reduce concrete cure times, enabling the molding of unique concrete geometries without the use of dedicated support molds and reinforcements. The microwave reflection chamber includes microwave emitters and a die. The die is used to shape the concrete into a desired cross-section. The microwave emitters are used to tune concrete viscosity and to rapidly cure the concrete pultrusion as it passes through the die. Microwave radiation, unlike conventional heating, penetrates through the concrete pultrusion, thereby heating the entire concrete mixture from the surface to the center of the mixture. This more even heating ability can provide more control over viscosity of the concrete pultrusion mixture passing through the die and reduce overall cure time. These improvements in control and curing of the concrete pultrusion mixture may allow for the creation of more complex cross-sectional geometries through pultrusion than can be typically achieved by traditional molding approaches.

For example, a concrete pultrusion system can include a creel system, a concrete infusion system, a microwave reflection chamber, and a pulling system. The creel system can include creels of textile material such as continuous linear fiber, braided fiber, filament wound and planer woven reinforcement. The creel system is operable to supply the textile material to the pultrusion system. The textile material is conveyed along the pultrusion system by the pulling system. For example, the textile material is conveyed from the creels first to the concrete infusion system. The concrete infusion system infuses a concrete mixture into the textile material forming a concrete infused textile material (CITM). The concrete infusion system can be, for example, a concrete infusion bath or a concrete flow through which the textile material is passed and infused with the concrete mixture. The CITM is then conveyed into the microwave reflection chamber where it is shaped and cured.

Some implementations include a cool down chamber configured to prevent excessive thermal stresses as the concrete perfusion cools and continues to cure after exiting the microwave reflection chamber.

In some implementations, additives that interact with microwave energy can be added to the concrete mixture to improve the heating capability of the microwave emitters. For example, additives can be added to concrete mixtures for added strength while allowing for a further reduction curing time as they will radiate heat from the microwaves into the mixture internally. Such additives include, but are not limited to, conductive iron, steel, or carbon fiber

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts a diagram of an exemplary concrete pultrusion system.

FIG. 2 depicts a block diagram of an exemplary control system for the concrete pultrusion system of FIG. 1.

FIG. 3 depicts a flow diagram that illustrates an example process for operating the concrete pultrusion system of FIG. 1.

FIG. 4 depicts a schematic diagram of a computer system that may be applied to any of the computer-implemented methods and other techniques described herein.

Like reference numbers and designations in the various drawings indicate like elements.

### DETAILED DESCRIPTION

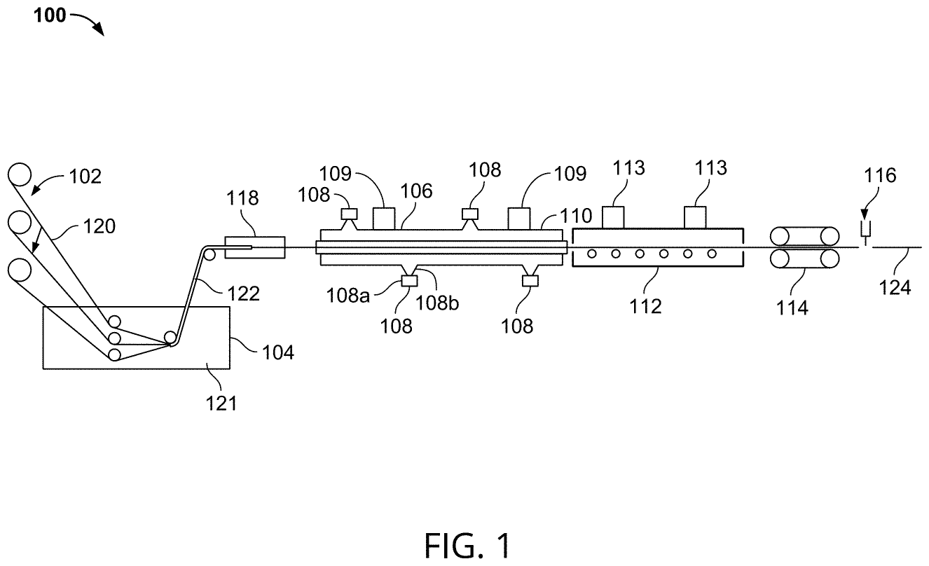

FIG. 1 depicts a diagram of an exemplary concrete pultrusion system 100. Concrete pultrusion system 100 includes a creel system 102, a concrete infusion system 104, a microwave chamber 106, a cooling chamber 112, a pulling system 114, and a cutting system 116. In some implementations, the concrete pultrusion system 100 includes a preforming die 118.

The creel system 102 can include a plurality of textile creels. Creel system 102 supplies textile material 120 to the concrete pultrusion system 100. More specifically, creel system 102 supplies the textile material 120 to a concrete infusion system 104. The textile material 120 can be, but is not limited to, continuous linear fiber, braided fiber, filament wound, planer woven reinforcement, or a combination thereof. Textile material 120 with poor adhesion properties to concrete can be precoated with an intermediate, surface bonding film (e.g. high temperature epoxy sand mixture) to improve adhesion to concrete.

The concrete infusion system 104 infuses the textile material 120 with a concrete mixture 121 providing concrete infused textile material (CITM) 122. For example, the concrete infusion system 104 can be a concrete infusion bath. The concrete mixture 121 can include, e.g., conventional portland cement, geopolymer based concrete using fine aggregates, or other types of cement. In some implementations, the concrete mixture 121 used in the infusion system 104 can contain additives. Such additives include, but are not limited to, chopped plastic, basalt, glass or cellulose reinforcing fibers, and/or chemical additives to change its physical properties and curing characteristics depending on the product application.

The preforming die 118 is used to consolidate the concrete and reinforcing fibers of the CITM 122 into an initial profile prior to heating in the microwave chamber 106. In some examples, preforming die 118 is heated. In some examples, preforming die 118 is unheated.

The microwave chamber 106 includes a die 110 and microwave emitters 108. The microwave chamber 106 is configured to capture and reflect microwaves emitted by emitters 108 towards the die 110. For example, the microwave chamber can be constructed as a Faraday cage. In some implementations, the microwave chamber 106 can be constructed of an electrically non-conductive housing with a conductive cage lining or a conductive cage embedded within the housing material.

In some implementations, the microwave chamber 106 can include a pressure control system. For example, the pressure control system can be configured to raise or lower the air pressure inside the chamber 106, the die 110 or both to shift the boiling point of water (or other additives) in the concrete mixture. For example, the microwave chamber 106, or sections thereof, can be substantially pressure tight. The pressure control system can include pneumatic pumps, piping, and valves coupled to the chamber and assembled to control the pressure within the chamber 106.

Die 110 is formed from an electrically non-conductive material. Die 110 forms the CITM into a final profile while the CITM is heated by microwave energy in the microwave chamber 106. Die 110 can be formed from materials such as ceramic or high temperature plastic, for example.

Unlike conventional pultrusion systems, die 110 is not heated directly. Rather, microwave energy is used to slowly heat the concrete in the CITM 122 between 60° C. and 80° C. (measured at the center of die 110) as the CITM 122 is passed through the microwave chamber. The microwave energy penetrates into the concrete mixture 120 promoting more even heating throughout the mixture when compared to other traditional heating mechanisms. The use of direct heating with microwaves (e.g., heating the concrete in the CITM 122 not the die 110) has the potential to unlock applications and techniques typically used in the composite space in the concrete space. The continuous nature of the pultrusion process described herein not only allows for more cost effective production of structural parts, but it may also eliminate the need for bespoke molds for different precast part lengths. Some implementations of the disclosed process have the potential to both reduce cost and increase the value of precast concrete. Additionally the ability to make more complex, lighter weight concrete geometries has the potential to significantly reduce the environmental impact of concrete elements by raising their specific strength.

If needed or desired, additives can be included in the concrete mixture 121 to further promote more even heating. For example, additives that are receptive to microwave energy can be added to the concrete mixture 121. Such additives include, but are not limited to, any one or combination of conductive iron, steel, carbon fiber, or other additives that will radiate heat into the mixture internally with the application of microwaves. Such additives may be added to concrete mixtures for added strength while also allowing for a further reduction curing time due to their interaction with the microwaves.

The microwave chamber 106 can control the heating process by adjusting characteristics of the microwave energy transmitted into the chamber to maintain proper heating. Characteristics of the microwave energy that can be controlled include, but are not limited to, power, frequency, pulse periods, or a combination thereof. For example, microwave power can be adjusted within ranges including, but not limited to, 1 kW to 20 kW or 0.1 kW to 2000 kW, for each magnetron. For example, microwave frequency can be adjusted within ranges including, but not limited to, 300 MHz to 300 GHz, 433.92 MHz to 40.00 GHz, for focused on a specific heating value of, e.g., 2.45 GHz.

More specifically, microwave emitters 108 transmit microwave energy into the microwave chamber as the CITM 122 is passed through the die 110. Multiple emitters 108 can be positioned along the length of the microwave chamber 108. Each emitter 108 can be arranged to direct microwave energy into a different region of the microwave chamber 106. In some implementations, the emitters 108 can be independently controlled. For example, emitters 108 can be operated at graduated power settings along the chamber 108. For example, emitters 108 near the entrance of the chamber 106 can be operated at a lower power than emitters 108 near the center to slowly bring the CITM 122 up to a desired internal temperature. Emitters 108 near the exit of the chamber 108 can be operated at a lower power than those in the center to reduce thermal stress one the CITM 122 when exiting the microwave chamber 106.

Each emitter 108 can include a magnetron 108a coupled to a waveguide 108b. The magnetron 1080a generates microwave energy and the waveguide 108b directs the microwave energy towards a desired region of the microwave chamber 106. For example, the waveguide 108b can be arranged on the print head 100 to direct microwave energy into a portion of the internal flow path 104. In some implementations, the waveguide 110b can be configured as a horn antenna.

Although FIG. 1 depicts the microwave emitters 108 as being directly attached to the microwave chamber 106, in some implementations the magnetrons 108a can be located separate from the chamber 106 and waveguides can be used to conduct the output of each magnetron 108a to a particular antenna (e.g., a horn antenna) positioned on the chamber 106. Each antenna can be arranged to direct the output microwave energy to a respective region of the microwave chamber 106.

In some implementations, multiple antennas can be driven by a single magnetron. For example, microwave antennas located in similar regions of the chamber 106 (e.g., at the entrance) can be driven by a common magnetron. As another example, a set of chamber entry microwave emitters 108 can include a common “entry” magnetron coupled to two or more horn antennas positioned in regions near the entrance of the chamber 106. Each of these “entry” antennas can be coupled to the “entry” magnetron by waveguides. Similar sets of antennas can be positioned along the length of the microwave chamber 106, with each set being driven by a respective magnetron.

In some implementations, the microwave chamber 106 includes curing sensors 109 to monitor the CITM 122 as it is passed through the microwave chamber 106 and die 110. Curing sensors 109 can include thermal sensors such as infrared heat detectors to monitor the temperature of the CITM 122. The amount of microwave energy transmitted into the microwave chamber 106 can be controlled in response to output of the curing sensors 109.

The CITM 122 is conveyed into the cooling chamber 112 to minimize thermal stresses during the curing process after exiting the microwave chamber 106. Cooling chamber 112 can be a calibrated cooling chamber to maintain the CITM 122 at an elevated temperature while the CITM 122 slowly cools to room temperature. In some implementations, the cooling chamber 112 is a passive insulated chamber. In some implementations, the cooling chamber 112 is actively heated. For example, the cooling chamber 112 can include steam or electric heaters spaced along the length of the cooling chamber 112. Different groups of heaters can be operated to maintain a progressively lowering temperature profile along the length of the cooling chamber 112.

In some implementations, the cooling chamber 112 includes curing sensors 113 to monitor the CITM 122 as it is passed through the cooling chamber 112. Curing sensors 113 can include thermal sensors such as infrared sensors to monitor the temperature of the CITM 122. The heaters in the cooling chamber 112 can be controlled in response to the output of the curing sensors 113, e.g., to maintain a steady cooling rate.

The pulling system 114 is used to convey the CITM 122 through the concrete pultrusion system 100. For example, the pulling system 114 can be tread type pullers to draw the CITM 122 through the concrete pultrusion system 100. The pulling system 114 controls the rate at which the CITM 122 is drawn through the concrete pultrusion system 100 including the microwave chamber 106. In some implementations, the rate at which the pulling system 114 conveys the CITM 122 can be adjusted based on output from the curing sensors 109, 113 in either or both of the microwave chamber 106 and the cooling chamber 112. In some examples, the pulling system 114 is operated at a rate that achieves a 15-30 minute dwell time for the CITM 122 in the microwave chamber 106.

Cutting system 116 can be a saw or water based cutter to trim the final concrete pultrusion parts 124 to a desired length.

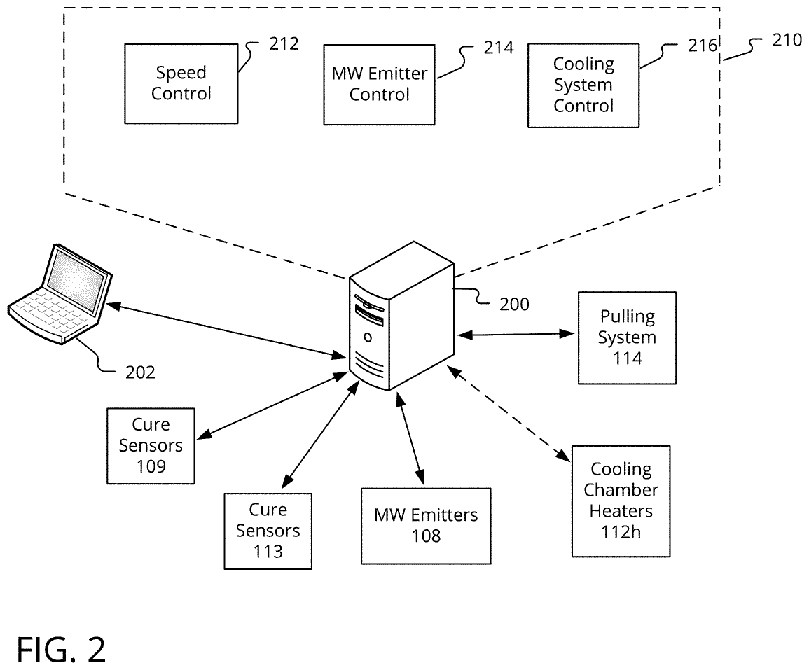

FIG. 2 is a block diagram of an exemplary control system 200 for a concrete pultrusion system 100. Control system 200 is configured to control various aspects of the concrete pultrusion process. For example, control system 200 can store and execute one or more computer instruction sets to control the execution of aspects of the concrete pultrusion processes described herein. For example, control system 200 is in electronic communication with the microwave chamber 106 (e.g., microwave emitters 108), the cooling chamber heaters 112h (if applicable), pulling system 114, and curing sensors 109, 113. Control system 200 can control the operations of the microwave chamber 106 (e.g., microwave emitters 108), the cooling chamber heaters 112h (if applicable), pulling system 114, and curing sensors 109, 113 to execute a concrete pultrusion process.

In some implementations, the control system 200 can be operated or controlled from a user computing device 202. User computing device 202 can be a computing device, e.g., desktop computer, laptop computer, tablet computer, or other portable or stationary computing device.

Control system 200 can include a set of operations modules 210 for controlling different aspects of a concrete pultrusion system 100. The operation modules 210 can be provided as one or more computer executable software modules, hardware modules, or a combination thereof. For example, one or more of the operation modules 210 can be implemented as blocks of software code with instructions that cause one or more processors of the control system 200 to execute operations described herein. In addition or alternatively, one or more of the operations modules can be implemented in electronic circuitry such as, e.g., programmable logic circuits, field programmable logic arrays (FPGA), or application specific integrated circuits (ASIC). The operation modules 210 can include a speed controller 212, a microwave (MW) emitter controller 214, and a cooling system controller 216.

Speed controller 212 controls the operation of the pulling system 114. For example, speed controller 212 can control the rate at which CITM 122 is conveyed through the concrete pultrusion system 100. In some implementations, the flow controller 212 can adjust speed of the pulling system 114 based on the output of curing sensors 109 and/or 113. For example, if the output of the curing sensors 113 in the cooling chamber 112 indicate an improper temperature gradient along the length of the CITM 122 in the chamber, the speed controller 212 can adjust the speed of the pulling system 114 to slow the cooling of the CITM 122.

The speed controller 212 can also operate the pulling system 114 in conjunction with the cutting system 116. For example, the speed controller 212 can include a counter to count rotations of the pulling treads. The counter values can be used to measure lengths of CITM 122 pulled through the concrete pultrusion system 100. In some implementations, the speed controller 212 can be calibrated to measure concrete pultrusion parts 124 to length, stop the pulling system 114 at a desired length, and activate the cutting system 116 to cut a part 124. For example, the speed controller 212 can be calibrated to operate the pulling system 114 treads for a particular number of rotations (or partial rotations) equivalent to the desired length of the part 124.

MW emitter controller 214 controls the operation of the microwave emitters 108 coupled to the microwave chamber 106. For example, the MW emitter controller 214 can control the magnetron(s) 108a to set or adjust characteristics of the microwave energy output by the microwave emitter(s) 108. Characteristics of the microwave energy that can be controlled include, but are not limited to, power, frequency, pulse periods, or a combination thereof. For example, microwave power can be adjusted within ranges including, but not limited to, 1 kW to 20 kW or 0.1 kW to 2000 kW, for each magnetron. For example, microwave frequency can be adjusted within ranges including, but not limited to, 300 MHz to 300 GHz, 433.92 MHz to 40.00 GHz, for focused on a specific heating value of, e.g., 2.45 GHz.

As discussed above, the microwave emitter(s) 108 can be controlled to maintain a desired heating profile in the microwave chamber 106. In some implementations, the MW emitter controller 214 can set the output of the microwave emitter(s) 108 to maintain application of a constant dose of microwave energy to the CITM 122 within die 110. In some implementations, the MW emitter controller 214 can control the output of different emitters 108 or sets of emitters 108 to apply different doses of microwave energy to the CITM 122 in different regions of the microwave chamber 106 at different regions of the die 110. For instance, the MW emitter controller 214 can control sets of emitters 108 to apply a heating profile that gradually increases the amount of heat applied to the CITM 122 from the entry of the microwave chamber 106 to the center of the microwave chamber 106.

In some implementations, the microwave meter(s) 108 can be controlled to maintain a predefined heating or temperature profile along a length of the microwave chamber. In some examples, the predefined heating or temperature profile can be specific to a partial die 110 (or a particular type of concrete profile produced by the die 110) being used in the microwave chamber. For example, the MW emitters 108 can be controlled to produce a heating profile along the microwave chamber 106 that is unique a particular die 110. For instance, the profile generated by one particular die 110 may be more suited to more rapid temperature increase along its length (e.g., to cure the CITM 122 more rapidly), while the profile generated by another particular die 110 may be more suited to a slower temperature increase.

In some implementations, MW emitter controller 214 can control the microwave output by the emitters 108 to heat the concrete mixture in the CITM 122 to a temperature just below boiling to facilitate more rapid curing. In some implementations, e.g., if a foam-like concrete consistency is desired, the MW emitter controller 214 can emitters 108 to heat the CITM 122 allow the concrete mixture to boil slightly, thereby producing a “foam like” concrete.

In some implementations, the control system 200 receives measurements from the curing sensor 109. For example, the control system 200 can receive measurements of the temperature of the CITM 122 at one or more points along microwave chamber 106. The control system 200 can use the measurements as feedback for controlling the output of the microwave emitter(s) 108. For example, the MW emitter controller 214 can adjust the output of the microwave emitter(s) 108 based on the measurements from the curing sensors 109. For instance, if the measurements indicate that the temperature of the CITM 122 is too low or too high at a given reference point along the length of the die 110, then the MW emitter controller 214 can increase or decrease (respectively) the output power of the microwave energy.

Cooling system controller 216 controls the operation of the heaters 112h in the cooling chamber 112. For example, the cooling system controller 216 can maintain appropriate temperatures along the cooling chamber 112 to minimize thermal stresses in the CITM 122 as it cools. The control system 200 can control operation of the cooling chamber 112 based on feedback from curing sensors 113. For example, the control system 200 can receive measurements of the temperature of the CITM 122 at one or more points along cooling chamber 112. The control system 200 can use the measurements as feedback for controlling the output of the cooling chamber heaters 112h.

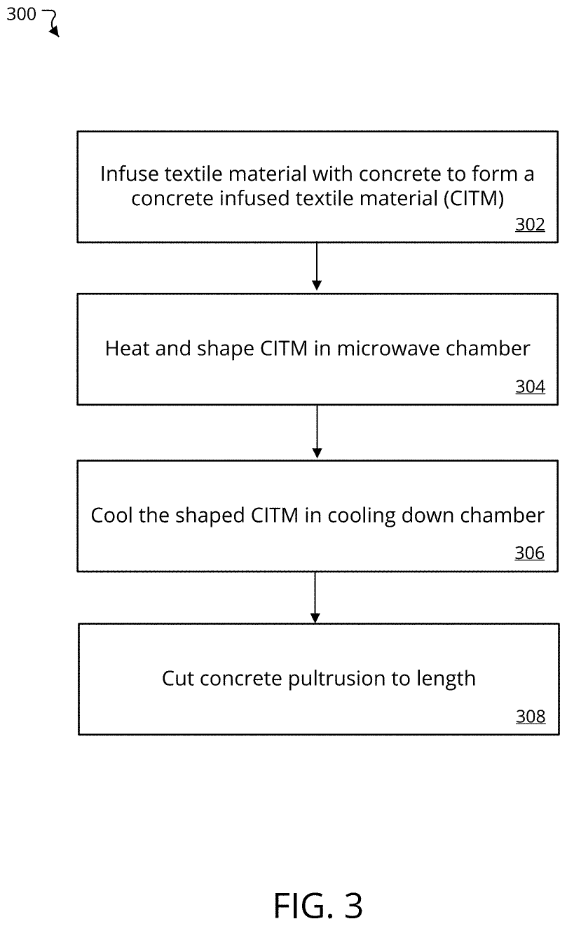

FIG. 3 is a flow diagram that illustrates a process 300 for controlling operation of a concrete additive manufacturing print head 100. The process 300 can be performed by one or more computing devices. For example, as discussed above, the process 300 may be performed by control system 200 of FIG. 2. For convenience, operations of process 300 is described as being performed by a control system. However, as noted above, some or all of the operations may be performed by various operation modules of an additive manufacturing control system.

The control system infuses textile material with concrete to form CITM (302). For example, the control system can control operation of the pulling system to convey textile material from a set of creels into a concrete infusion bath or a flow of concrete mixture to infuse the textile material with concrete. After being infused with concrete, the resulting CITM is conveyed into a microwave chamber.

The control system heats and shapes the CITM in a microwave chamber (304). For example, the control system can control one or more microwave emitters to irradiate the CITM with microwave energy while the CITM is conveyed through an electrically non-conductive forming die disposed within the microwave chamber. The CITM is formed into a desired profile by the die as it is heated and cured by the microwave energy. As discussed above, the control system can control the heating profile provided by the microwave emitters along the length of the microwave chamber to provide a desired heating and curing rate for the CITM within the die. In some implementations, the control system can adjust output characteristics of the microwave emitters based on feedback from curing sensors positioned along the microwave chamber.

The control system cools the shaped CITM in a cooling chamber (306). The CITM is conveyed into a cooling chamber to avoid excess thermal stress after exiting the microwave chamber. The control system can control heaters within the cooling chamber to maintain the internal temperature of the CITM as it cools and continues to cure to minimize thermal stress.

The control system cuts the concrete pultrusion to a desired length (308). For example, the control system can control the pulling system and a cutting system to cut concrete pultruded parts to a desired length. In some implementations, the control system can measure part length based on rotations (or partial rotations) of a tread pulling system and stop or pause the treads when a desired length of concrete pultrusion has been drawn past the cutting system. The control system can then control the cutting system to cut the concrete pultrusion to length.

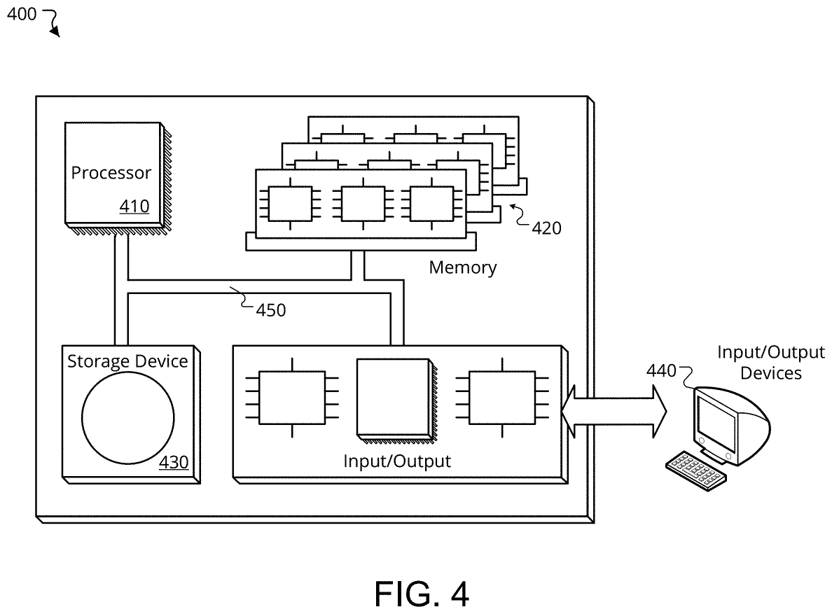

FIG. 4 is a schematic diagram of a computer system 400. The system 400 can be used to carry out the operations described in association with any of the computer-implemented methods described previously, according to some implementations. In some implementations, computing systems and devices and the functional operations described in this specification can be implemented in digital electronic circuitry, in tangibly-embodied computer software or firmware, in computer hardware, including the structures disclosed in this specification (e.g., system 400) and their structural equivalents, or in combinations of one or more of them. The system 400 is intended to include various forms of digital computers, such as laptops, desktops, workstations, personal digital assistants, servers, blade servers, mainframes, and other appropriate computers, including vehicles installed on base units or pod units of modular vehicles. The system 400 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transducer or USB connector that may be inserted into a USB port of another computing device.

The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. The processor may be designed using any of a number of architectures. For example, the processor 410 may be a CISC (Complex Instruction Set Computers) processor, a RISC (Reduced Instruction Set Computer) processor, or a MISC (Minimal Instruction Set Computer) processor.

In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

In addition to the embodiments described above, innovative aspects of the subject matter described in this specification are incorporated in the following embodiments.

Embodiment 1 is a concrete pultrusion system comprising: a creel system operable to supply textile material to a concrete infusion system; a pulling system operable to convey concrete infused textile material (CITM) along the pultrusion system; a microwave chamber comprising an electrically non-conductive die disposed therein, the microwave chamber operable to heat concrete infused in the textile material by irradiating the CITM with microwave energy as the CITM is conveyed through the microwave chamber, and the die operable to shape the CITM as the CITM is conveyed through the microwave reflection chamber; and a cooling chamber operable to maintain heat in the CITM as the CITM is conveyed through the cooling chamber allowing the concrete to cure while a temperature of the CITM is reduced.

Embodiment 2 is the system of embodiment 1, wherein the microwave chamber comprises one or more microwave emitters, each microwave emitter comprising a magnetron operatively coupled to a waveguide horn.

Embodiment 3 is the system of embodiment 2, wherein an output of the waveguide horn is directed into the microwave chamber.

Embodiment 4 is the system of any one of embodiments 1-3, wherein the microwave chamber comprises a plurality of microwave antennas spaced along a length of the microwave chamber, each antenna arranged to emit microwave energy into the microwave chamber.

Embodiment 5 is the system of any one of embodiments 1-4, wherein the concrete infusion system infuses the textile material with a concrete mixture comprising additives that are receptive to microwave energy.

Embodiment 6 is the system of any one of embodiments 1-5, further comprising a control system operatively coupled to the microwave chamber, the control system configured to control operation of the microwave chamber.

Embodiment 7 is the system of embodiment 6, wherein controlling operation of the microwave chamber comprises controlling one or more microwave emitters to adjust one or more characteristics of the microwave energy emitted into the microwave chamber.

Embodiment 8 is the system of embodiment 7, wherein the one or more characteristics comprise power or frequency of the microwave energy.

Embodiment 9 is the system of any one of embodiments 7 or 8, wherein controlling operations of the microwave chamber comprises: receiving sensor measurements of characteristics of the CITM in the microwave chamber; and controlling one or more microwave emitters to adjust one or more characteristics of the microwave energy based on the measured characteristics of the CITM.

Embodiment 10 is the system of any one of embodiments 1-9, further comprising a preforming die configured to form the CITM into an initial profile prior to the CITM being conveyed into the microwave chamber.

Embodiment 11 is a pultrusion method comprising: conveying a textile material through a concrete infusion system to provide a concrete infused textile material (CITM); heating and shaping the CITM by conveying the CITM through a microwave chamber comprising an electrically non-conductive die disposed therein, the microwave chamber operable to heat concrete infused in the textile material by irradiating the CITM with microwave energy as the CITM is conveyed through the microwave chamber, and the die operable to shape the CITM as the CITM is conveyed through the microwave chamber; and cooling the CITM by conveying the CITM through a cool down chamber operable to maintain heat in the CITM as the CITM is conveyed through the microwave chamber allowing the concrete to cure while a temperature of the CITM is reduced.

Embodiment 12 is the method of embodiment 11, wherein heating the CITM comprises controlling the output energy of one or more microwave emitters along a length of the microwave chamber.

Embodiment 13 is the method of embodiment 12, wherein controlling the one or more microwave emitter comprises: receiving temperature measurements of the CITM at one or more positions in the microwave chamber; and controlling the one or more microwave emitters to adjust one or more characteristics of the first microwave energy based on at least one of the temperature measurements of the CITM.

Embodiment 14 is the method of any one of embodiments 11-13, further comprising cutting the CITM to a desired length after the CITM exits the cooling chamber.

Embodiment 15 is the method of any one of embodiments 11-14, wherein the CITM comprises additives that are receptive to microwave energy.

Embodiment 16 is a microwave chamber for a concrete pultrusion system, the microwave chamber comprising: an electrically non-conductive die disposed therein; a plurality of microwave antennas arranged along a length of the microwave chamber, each antenna arranged to direct microwave energy into a respective region of the microwave chamber and towards a concrete infused textile material (CITM) being passed through the electrically non-conductive die; a plurality of magnetrons, each magnetron operatively coupled to one or more of the microwave antennas; and a control system operatively coupled to the magnetrons, the control system configured to control operation of the magnetrons.

Embodiment 17 is the microwave chamber of embodiment 16, wherein controlling operation of the microwave chamber comprises controlling the magnetrons to adjust one or more characteristics of the microwave energy emitted by the antennas into the microwave chamber.

Embodiment 18 is the microwave chamber of embodiment 17, wherein the one or more characteristics comprise power or frequency of the microwave energy.

Embodiment 19 is the microwave chamber of any one of embodiments 16-18, wherein controlling operations of the microwave chamber comprises: receiving temperature measurements of the CITM at one or more positions in the microwave chamber; and controlling the magnetrons to adjust one or more characteristics of the microwave energy based on at least one of the temperature measurements of the CITM.

Embodiment 20 is the microwave chamber of any one of embodiments 16-19, wherein controlling operations of the microwave chamber comprise controlling the magnetrons to maintain a predefined heating profile along a length of the microwave chamber.

1. A concrete pultrusion system comprising:
a creel system operable to supply textile material to a concrete infusion system;
a pulling system operable to convey concrete infused textile material (CITM) along the pultrusion system;
a microwave chamber comprising an electrically non-conductive die disposed therein, the microwave chamber operable to heat concrete infused in the textile material by irradiating the CITM with microwave energy as the CITM is conveyed through the microwave chamber, and the die operable to shape the CITM as the CITM is conveyed through the microwave reflection chamber; and
a cooling chamber operable to maintain heat in the CITM as the CITM is conveyed through the cooling chamber allowing the concrete to cure while a temperature of the CITM is reduced.

2. The system of claim 1, wherein the microwave chamber comprises one or more microwave emitters, each microwave emitter comprising a magnetron operatively coupled to a waveguide horn.

3. The system of claim 2, wherein an output of the waveguide horn is directed into the microwave chamber.

4. The system of claim 1, wherein the microwave chamber comprises a plurality of microwave antennas spaced along a length of the microwave chamber, each antenna arranged to emit microwave energy into the microwave chamber.

5. The system of claim 1, wherein the concrete infusion system infuses the textile material with a concrete mixture comprising additives that are receptive to microwave energy.

6. The system of claim 1, further comprising a control system operatively coupled to the microwave chamber, the control system configured to control operation of the microwave chamber.

7. The system of claim 6, wherein controlling operation of the microwave chamber comprises controlling one or more microwave emitters to adjust one or more characteristics of the microwave energy emitted into the microwave chamber.

8. The system of claim 7, wherein the one or more characteristics comprise power or frequency of the microwave energy.

9. The system of claim 6, wherein controlling operations of the microwave chamber comprises:
receiving sensor measurements of characteristics of the CITM in the microwave chamber; and
controlling one or more microwave emitters to adjust one or more characteristics of the microwave energy based on the measured characteristics of the CITM.

10. The system of claim 1, further comprising a preforming die configured to form the CITM into an initial profile prior to the CITM being conveyed into the microwave chamber.

11. A pultrusion method comprising:
conveying a textile material through a concrete infusion system to provide a concrete infused textile material (CITM);
heating and shaping the CITM by conveying the CITM through a microwave chamber comprising an electrically non-conductive die disposed therein, the microwave chamber operable to heat concrete infused in the textile material by irradiating the CITM with microwave energy as the CITM is conveyed through the microwave chamber, and the die operable to shape the CITM as the CITM is conveyed through the microwave chamber; and
cooling the CITM by conveying the CITM through a cool down chamber operable to maintain heat in the CITM as the CITM is conveyed through the microwave chamber allowing the concrete to cure while a temperature of the CITM is reduced.

12. The method of claim 11, wherein heating the CITM comprises controlling the output energy of one or more microwave emitters along a length of the microwave chamber.

13. The method of claim 12, wherein controlling the one or more microwave emitter comprises:
receiving temperature measurements of the CITM at one or more positions in the microwave chamber; and
controlling the one or more microwave emitters to adjust one or more characteristics of the first microwave energy based on at least one of the temperature measurements of the CITM.

14. The method of claim 11, further comprising cutting the CITM to a desired length after the CITM exits the cooling chamber.

15. The method of claim 11, wherein the CITM comprises additives that are receptive to microwave energy.

16. A microwave chamber for a concrete pultrusion system, the microwave chamber comprising:
an electrically non-conductive die disposed therein;
a plurality of microwave antennas arranged along a length of the microwave chamber, each antenna arranged to direct microwave energy into a respective region of the microwave chamber and towards a concrete infused textile material (CITM) being passed through the electrically non-conductive die;
a plurality of magnetrons, each magnetron operatively coupled to one or more of the microwave antennas; and
a control system operatively coupled to the magnetrons, the control system configured to control operation of the magnetrons.

17. The microwave chamber of claim 16, wherein controlling operation of the microwave chamber comprises controlling the magnetrons to adjust one or more characteristics of the microwave energy emitted by the antennas into the microwave chamber.

18. The microwave chamber of claim 17, wherein the one or more characteristics comprise power or frequency of the microwave energy.

19. The microwave chamber of claim 16, wherein controlling operations of the microwave chamber comprises:
receiving temperature measurements of the CITM at one or more positions in the microwave chamber; and
controlling the magnetrons to adjust one or more characteristics of the microwave energy based on at least one of the temperature measurements of the CITM.

20. The microwave chamber of claim 16, wherein controlling operations of the microwave chamber comprise controlling the magnetrons to maintain a predefined heating profile along a length of the microwave chamber.
